(19) United States
(12) Patent Application Publication
(10) Pub. No.: US 2020/0311838 A1
(43) Pub. Date: Oct. 1, 2020

(54) System and Method for the Collection of United States of America Nationwide Building Code for all Jurisdictions having Authority to Adopt and Enforce Building Code and for the Determination of the Jurisdiction with Authority for Building Code Adoption and Enforcement at the Location of Real Property and the Supplying of the Building Code for Real Property to the User

(71) Applicant: Garrett John Kurtt, Englewood, CO (US)

(72) Inventor: Garrett John Kurtt, Englewood, CO (US)

(21) Appl. No.: 16/364,082

(22) Filed: Mar. 25, 2019

(51) Int. Cl. G06Q 50/16; G06Q 50/26; G06F 16/29

(52) U.S. Cl. CPC G06Q 50/16; G06F 16/29; G06Q 50/26

(57) ABSTRACT

A computerized system that compiles real property addresses so that the location of a specific real property address may he determined so that the user will be provided the building code information that applies to the specific real property address based upon the municipal jurisdiction that has the authority to adopt and enforce building code. This system will also have a method by which the building code of each jurisdiction within the United States is collected and stored in a Master Data Base. This computerized system will also provide information which will affirmatively inform the user when there has not been an adoption of building code at a specific real property address. This system will also he able to monitor real property addresses and ensure that any adoptions of building code are updated in the Master Data Base in real time.

### BACKGROUND OF THE INVENTION

### (a) Field of the Invention

This present invention and application relates to the system and method for the deter urination of the municipality with jurisdictional authority for the adoption and enforcement of building code at an address within the United. States and the gathering of the building code information from each municipality. This invention relates to the fields of construction design, physical construction, insurance underwriting, and claims evaluation. This system collects the building code information from each municipality within the United States of America and its possessions and stores it in a Master Data Base referenced by the Federal Informational Processing Standards (FIPS) code, Minor Civil Division (MCD) code, Census County Divisions (CCD) code, or Unorganized Territory (UT) code. Once the user inputs the address of the real property, the software compares the Federal Informational Processing Standards (FIPS) code, Minor Civil Division (MCD) code, Census County Divisions (CCD) code, or Unorganized Territory (UT) code that contains the real property address to the code within the Master Data Base and informs the user of the identity of the municipality with authority to adopt and enforce the building code at the real property's address and then provides the building code in real time to the code generated by the inputting of the real property address and then informs the user of the identity of the municipality with authority to adopt and enforce the building code at the real property's address and then provides the building code in real time.

### (b) Discussion of Known Art

The use of Google's Geocoding application programming interface in order to convert a physical street address into a geographic latitude and longitude coordinate is known. The use of the United States Census Bureau Topographical Integrated Geographic Encoding and Referencing Product in order to gather polygon shape files is known. The use of the Javascript geospatial module Turf in order to plot geographic latitude and longitude points into polygon shapefiles representing places such as states, counties, cities, townships, and towns is known. An example of known systems that utilize these programs is U.S. Pat. No. 7,716,093 to Johnson et. al. This patent teaches using polygon shape files to locate the taxing municipality with sales taxing authority.

The use of data bases to compile and sort data is taught in many patents. For instance U.S. Pat. Nos. 7,584,884 B2 and 10,169,829 B2 to Fox et. al. teaches the use systems and methods for managing sales tax information where missing sales tax information is retrieved from a source possessing the missing information. U.S. Pat. No. 5,335,169 to Chong teaches a computer system for tracking multiple types of sales tax assessments for different taxing authorities for different types of sales transactions.

The use of obtaining data from entities and merging data is taught by U.S. Pat. No. 8,244,619 to Kagarlis et. al. teaching the merging of data from various sources such as sales transactions and tax assessments in order to use as inputs for forming of values associated with real estate. U.S. Pat. No. 10,147,150 to Carrington describes a method and system for retrieving and serving regulatory history for real property.

### SUMMARY

Building regulation has been around in various forms since antiquity. In the United States, major cities began to adopt and enforce building codes near the end of the 19^{th} century. Initially intended to reduce the threat of tire in large urban areas, over time, the scope of building regulations has expanded to address areas such as structural integrity, ventilation, and appropriate construction materials with the main purpose being to protect public health, safety, and general welfare as they relate to the construction and occupancy of buildings.

Today, building codes are a set of rules that specify minimum standards for the construction of buildings and other structures. To be constructed and/or repaired, buildings must conform to the specified code in order to obtain a building permit. The issuer of a building permit is typically the state or local government where the building does or will reside. Although not themselves legally binding, building code does become law for a particular jurisdiction when formally adopted by the appropriate governmental authority, Today, the vast majority of communities within the United States have formally adopted building code and have a system in place for building regulation. Given the thousands of cities, towns, townships, boroughs, counties, etc. that make up the United States, deciphering which municipality has the authority to issue a building permit as well as what building codes are adopted can be daunting. Municipalities can overlap one another and cross county boundaries. Simply using the common city name or zip code provided from a given postal street address many times does not provide the correct information regarding the government entity that has the authority to issue building permits or what the adopted building codes are. In other instances, a particular municipality may contract out their building department services to the county it resides in, to a private institution, or to another municipality entirely.

The present invention solves the burdensome task of finding the appropriate governmental authority that adopts and enforces the local building code, issues building permits, as well as what are the specific adopted building codes. The invention involves a system comprised of computer software and databases that work in concert to deliver accurate, site-specific, building code and contact information as United States postal addresses are not always accurate when determining where a real property is located.

This invention allows the user to easily access the adopted building code and jurisdictional building contact information. This allows participants in the system, including federal, state and local government officials, building contractors, building subcontractors, property insurance underwriters, property insurance actuaries, property insurance adjusters, building property owners, design professionals, architects, engineers, and construction professionals to save time and money as they do not have to search for the appropriate building authority and building code. The system determines the municipal jurisdiction with the authority to adopt code, enforce code, and issue building permits and then provides this information along with the adopted building code within a comprehensive code report. This invention will have an impact on protecting classes of entities and persons from negligence, misrepresentation, and fraud as the program will simplify the process by which a general contractor, real property owner, insurance company, design professional, or buyer of the home may determine, based upon a property's location, which municipality within the state in which the real property is located has the jurisdictional authority to adopt building codes, enforce building codes, and to issue building permits. This method and system of evaluating in which polygon shapefiles representing jurisdictions real property is located and taking this information and determining which jurisdiction in which the real properly is located has jurisdictional authority to adopt building code and which building code the jurisdiction has adopted results in a standardized system producing accurate, real time building code information to the end user thus solving the problem regarding whether or not a jurisdiction has adopted building code and what building code has been adopted, and therefore, enforced by the jurisdiction.

The invention includes a system that begins with a user inputting the street address of real property. Using commercially available third-party databases and Global Positioning System technology, the provided street address is gees-positionally defined by geographical latitude and longitude coordinates. These coordinates are then plotted against available census data in the form of shapefiles. In the United States, each physical street address resides within a particular state and county. Furthermore, each address can fall within a smaller subdivision of a county, such as a city or a town. Each of these potential jurisdictional areas has clearly defined shapefile boundaries. Utilizing a point-in-polygon algorithm the system identifies all relative, jurisdictions that the street address resides in. In other words, the system provides the state, county, and potential further areas (i.e. county subdivision or city) that contain the street address. All jurisdictions within the census data are provided with a FIPS (Federal Information Processing Standard), MCD (Minor Civil Division) code, Census County Divisions (CCD) code, or an Unorganized Territory (UT) code containing a unique number combination, The relative jurisdictions, based on the provided street address, are correlated with their unique census FIPS, MCD, CCD, or UT code.

Based on locational logic, starting smallest (city, town, etc.) and moving up through the larger jurisdictions (consolidated city, county subdivision, county then state) each FIPS, MCD, CCD, or UT code is correlated within a master database to retrieve the appropriate building code and jurisdictional authority contact information and display it in a provided report.

### BRIEF DESCRIPTION OF DRAWINGS

FIG. 1 is a schematic view of the process by which the computer program takes an input of an address of real property, determines the geographic latitude and longitude of the inputted real property address, determines which municipality has jurisdictional control over the adoption and enforcement of building codes, and provides the user with this information as well as the applicable building code.

FIG. 2 shows a real property address that has been converted to a geographic latitude and longitude point and plotted within polygon shape files. In this figure the blue dot represents the geographically plotted address and it is contained within three polygon shapefiles.

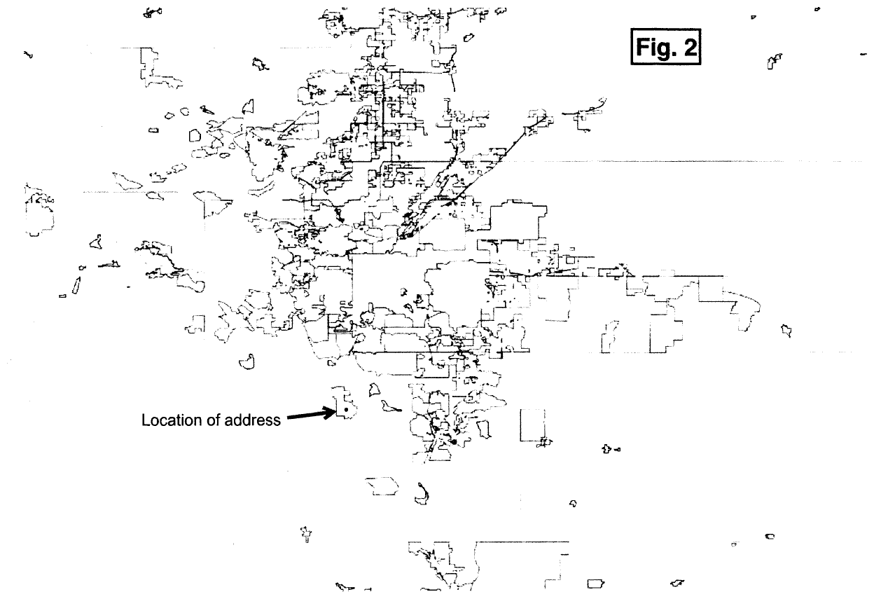

FIG. 3 is a schematic of the logic loop referenced in FIG. 1 at step 8. This figure shows the manner in which the logic loop operates once the real property address is converted to a geographic latitude and longitude point and located within a polygon shapefile and the metadata for the location of the property within polygon shape files is compared to the jurisdictions which make up the polygon shapefiles in order to determine which jurisdiction has the authority to adopt and enforce building code. This example uses the locations defined as a “place”, a “consolidated city”, “county subdivision”, “county”, and “state” and demonstrates the how the software starts with the smallest location in the smallest polygon and checks the jurisdiction from smallest to largest and stops when it finds the jurisdiction that has the authority to adopt and enforce building code.

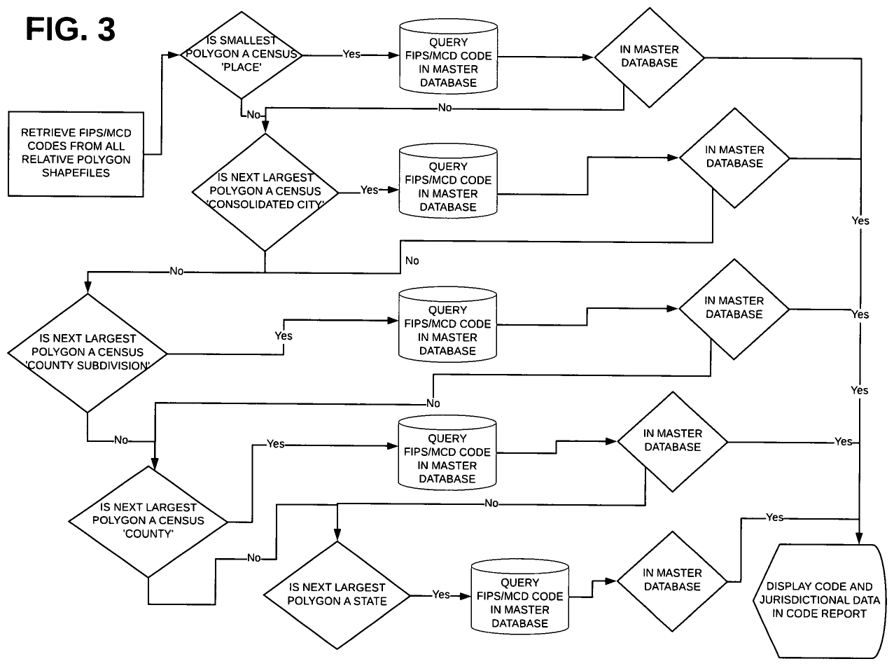

### DETAILED DESCRIPTION Of PREFFERRED EXEMPLARY EMBODIMENTS

While the invention will be described and disclosed herein in connection with certain preferred embodiments, the description is not intended to limit the invention to the specific embodiments shown and described here, but rather the invention is intended to cover all alternative embodiments and modifications that fall within the spirit and scope of the invention as defined by the claims included herein as well as any equivalents of the disclosed and claimed invention.

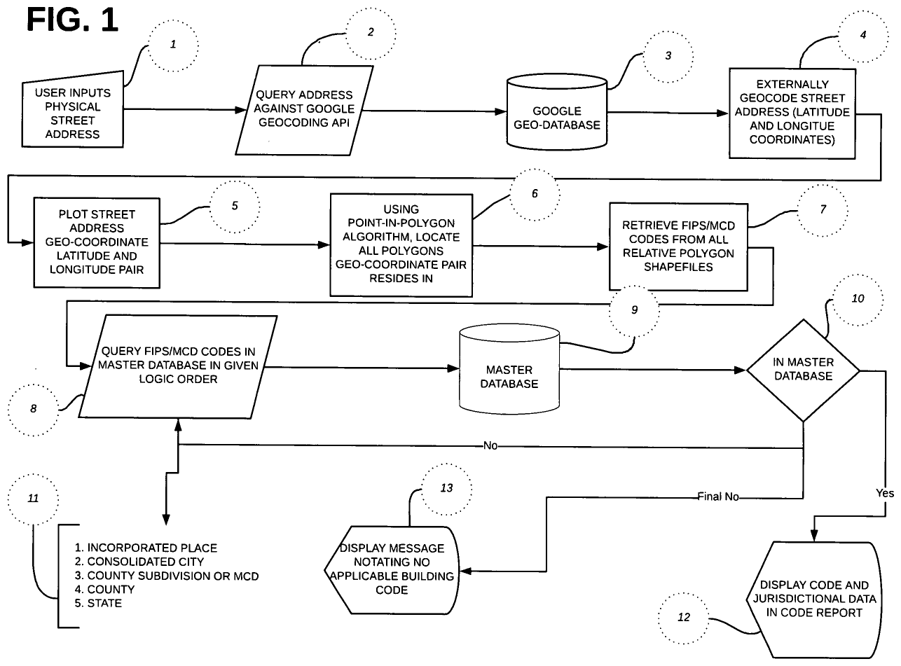

The utility patent this application describes allows a user to input an address of real property so that the user is provided with the jurisdiction having authority to adopt and enforce building codes is identified and provided with the building code applicable to the restoration project being contemplated by the user. This system includes user input/output interface, a tangible storage medium and a hardware processor. FIG. 1 is a schematic view of a presently preferred process which the invention follows. At step 1 the user inputs a postal street address. Utilizing Google's Geocoding application programming interface (API), the user provided street address is converted into geographic latitude and longitude coordinates (steps 2, 3 and 4). These geographical coordinates are then plotted (step 5) on a map of the United States. This map is comprised of shapefiles gathered via the commercially available US Census Bureau's TIGER products. These shapefiles (updated annually) display vector data (features such as points, lines and polygons) that represent all legal and statistical geographic areas within the US. The provided latitude and longitude geographical coordinates can be thought of as an (X, Y) coordinate pair, which, once plotted on the aforementioned 2-dimensional map of the United States, can be used to assess which polygons contain the geographic coordinates. Step 6 utilizes a point-in-polygon algorithm that determines whether the given (X, Y) coordinate is inside or outside a polygon. This is completed by using the Javascript geospatial module, Turf. Using the geospatial coordinates as inputs into the Turf function, ‘booleanPointInPolygon’, a collection of polygons that contains the given coordinate point is ascertained. Each polygon (representative of a legal or statistical governmental boundary) contains various metadata such as a unique geographic identifier (FIPS or MCD code) and the legal type of polygon (city/town, township, county, etc). Step 7 retrieves the relative IFPS/MCD code and the polygon type from the stored polygons (gathered in step 6) that were found to house the provided geographic coordinates. The FIPS/MCD code links to the master database. At step 8 a logic loop is utilized, beginning with the smallest potential polygon, a census defined Incorporated Place (i.e. city or town), the specified FIPS/MCD code is queried against the master database. If the relative FIPS/MCD is not contained within the master database then that particular governmental authority does not issue building permits and the next largest potential polygon's FIPS/MCD codes is queried against the master database (step 10). This is process is continued following the specified order of Place (city/town/village), Consolidated City, County Subdivision, County, and State (step 11) until a matching FIPS/MCD code within the master database is found. Once found, the building code and jurisdictional data is then displayed to the user (step 12). If no data exists for the relative FIPS/MCD code then a message is displayed conveying there is no applicable building code for that area (step 13).

What is claimed is:

1. A method of compiling a database of property addresses for the determination of which jurisdiction has adoption and enforcement authority of building code as well as compiling a data base of United States of America state municipalities building code adoption comprising the following steps:
gathering Google's Geocoding application programming interface (API) which converts a provided street address into geographic latitude and longitude coordinates;
gathering shapefiles from the United States Census Bureau Topographically Integrated Geographic Encoding and Referencing product where;
the shapefiles display vector data that represent all legal and statistical geographic areas with the United States where;
the shapefiles vector data contain features such as points, lines and polygons;
and gathering building code adoption information from each municipality in the United States of America;

2. The method of claim 1 in which the property address is plotted by way of a point-in-polygon algorithm that determines which polygon a given latitude and longitude point is located within the United States of America, where:
a polygon is defined as plane two dimensional figure that is described by a finite number of straight line segments connected to form a closed polygonal chain, where;
the segments of a polygonal circuit are called its edges or sides and the points where two edges meet are the polygon's vertices. The interior of a solid polygon is called its body, where;
each polygon may he contained within another polygon representing a place such as a state, county, city, a township, or a town, where;
the points lying on the border (the segments) of the polygon are considered to be inside the polygon;

3. The method of claim 2 utilizing the Javascript geospatial module Turf where:
the point-in-polygon utilizes geospatial coordinates as inputs into the Turf function, “booleanPointInPolygon”, where;
a collection of polygons that contain a given latitude and longitude point are ascertained where;
the collection of polygons represents places such as states, counties, cities, townships, and towns;

4. The method of claim 3 utilizing metadata which represent the polygon's unique geographic identifier and the legal type of polygon, where:
the metadata includes unique geographic identifiers such as Federal Information Processing Standards (FIDS) code which uniquely identified counties and county equivalents iii the United States, where;
the Federal Information Processing Standards code contains a Minor Civil Division (MCD) Code that represent primary governmental and/or administrative divisions of a county, such a as a civil township, precinct, or magisterial district, where;
the Federal Informational Processing Standards code also contains Census County Divisions (CCD) which represent subdivisions of counties, where;
the Federal Informational Processing Standards code also contains Unorganized Territory (UT) codes representing areas or regions of land without a normally constituted system of government, where;

5. The method of claim 4 in which the metadata represents the boundary definition of the polygon, where;
the metadata is used to determine where a point is located within a FIPS, MCD, CCD, or UT.

6. The method of claim 5 that utilizes a point-in-polygon algorithm that determines whether a given latitude and longitude coordinate is inside of outside a polygon.

7. The method of claim 6 in which the FIPS/MCD/CCD/UT code is linked to the Master Data Base where;
the Master Data Base compares each FIPS/MCD/CCD/UT in a smallest to largest polygon shape in which the address latitude and longitude point is located to determine which municipality as defined by each polygon shape has jurisdictional authority to adopt unified building code.

8. The method of claim 7 in which the Master Data Base is searched to determine the smallest potential polygon by:
using a logic loop to compare the FIPS/MCD/CCD/UT code is compared to the census defined Incorporated Place, where;
if the FIPS code/MCD/CCD/UT code is not contained within the Master Data Base then the program tells the user that the jurisdiction within the polygon shape does not have the authority to adopt building code, where;
if the FIPS code/MCD/CCD/UT code is contained within the Master Data Base then the program tells the user that the jurisdiction within the polygon shape does have the authority to adopt building code.

9. The method of claim 8 in which a logic loop is used to search the next largest jurisdiction as defined by the FIPS/MCD/CCD/UT code, usually at this point a Consolidated City, where;
if the FIPS code/MCD/CCD/UT code is not contained within the Master Data Base then the program tells the user that the jurisdiction within the polygon shape does not have the authority t adopt building code, where;
if the FIPS code/MCD/CCD/UT code is contained within the Master Data Base then the program tells the user that the jurisdiction within the polygon shape does have the authority to adopt building code.

10. The method of claim 9 in which a logic loop is used to search the next largest jurisdiction as defined by the FIPS/MCD/CCD/UT code, usually at this point a County Subdivision, where;
if the FIPS code/MCD/CCD/UT code is not contained within the Master Data Base then the program tells the user that the jurisdiction within the polygon shape does not have the authority to adopt building code, where;
if the FIPS code/MCD/CCD/UT code is contained within the Master Data Base then the program tells the user that the jurisdiction within the polygon shape does have the authority to adopt building code.

11. The method of claim 10 in which a logic loop is used to search the next largest jurisdiction as defined by the FIPS/MCD/CCD/UT code, usually at this point a County, where;
if the FIPS code/MCD/CCD/UT code is not contained within the Master Data Base then the program tells the user that the jurisdiction within the polygon shape does not have the authority to adopt building code, where;
if the FIPS code/MCD/CCD/UT code is contained within the Master Data Base then the program tells the user that the jurisdiction within the polygon shape does have the authority to adopt building code.

12. The method of claim 11 in which a logic loop is used to search the next largest jurisdiction as defined by the FIPS/MCD/CCD/UT code, usually at this point a State, where;
if the FIPS code/MCD/CCD/UT code is not contained within the Master Data Base then the program tells the user that the jurisdiction within the polygon shape does not have the authority to adopt building code, where;
if the FIPS code/MCD/CCD/UT code is contained within the Master Data Base then the program tells the user that the jurisdiction within the polygon shape does have the authority to adopt building code.

13. The method of claim 12 in which a logic loop has completed its search of each polygon shape in which a latitude and longitude point s located as defined by the FIPS/MCD/CCD/UT code, where;
the FIPS code/MCD/CCD/UT code is not contained within the Master Data Base so the user is told that the inputted property address is not within the jurisdiction of any jurisdiction which has adopted building code.

14. The method of claims 7, 8, 9, 10, 11, and 12 in which once the polygon shape corresponding to the jurisdiction which has authority to adopt building code is determined, the building code and jurisdictional data arc displayed to the user.

15. The method of claims 1 through 14 wherein the software described and contemplated by these claims and this patent application is accessed by computer, smartphone, tablet or other smart device to a website. or by downloading the standalone application via an iPhone or Android device.

16. The method of claims 1 through 14 wherein the software described and contemplated by these claims and this patent application is by downloading the standalone application via an iPhone or Android device.

17. The method of claims 1 through 14 wherein the data being utilized is stored in the cloud utilizing Amazon Web Server Services.

18. The method of claims 1 through 14 wherein the data being utilized is stored in the cloud utilizing a private server.

19. The method of claims 1 through 14 wherein the data is accessed and managed via NoSQL and PostgreSQL tools.

20. The method of claims 1 through 14 wherein the software computation is completed with Amazon Web Services service and utilizes Amazon Web Services' content and delivery network.
